(19) United States
(12) Patent Application Publication
(10) Pub. No.: US 2001/0034770 A1
(43) Pub. Date: Oct. 25, 2001

(54) Method and device for implementing networked terminals in graphical operating environment

(76) Inventor: Terry O'Brien, Mission, KS (US)

Correspondence Address: Richard R. Johnson, SHOOK, HARDY & BACON L.L.P, One Kansas City Place, 1200 Main Street, Kansas City, MO, 64105-2118, US

(21) Appl. No.: 09/766,177

(22) Filed: Jan. 19, 2001

Related U.S. Application Data
(60) Provisional application No. 60/198,944, filed on Apr. 21, 2000.

(51) Int. Cl. G06F 15/167; G06F 15/16

(52) U.S. Cl. 709/212; 709/217

(57) ABSTRACT

A method and device for implementing a network of terminal computers implementing a graphical operating environment from a common central processing system. The central processing system generates a display image for the one or more terminals as frame buffer data that is reduced, compressed and transferred to the individual terminals. As the display needs to be updated, the central processing system generates a new display, calculates the change in the updated data and the previous data, and transmits the change data. The present invention facilitates the implementation of the graphical operating environment by mitigating the amount of information required to be transmitted to each individual terminal.

### FIELD OF THE INVENTION

In general, the present invention relates to computer networks, and in particular, to a method and device for networking computer terminals in a graphical operating environment.

### BACKGROUND OF THE INVENTION

In general, open-ended computer networks servicing a plurality of users are known. One specific conventional embodiment of an open-ended computer network includes one or more terminals connected to a single central computing system such that the central computing system executes all of the processes requested by the user at each terminal. Generally, each of these terminals only requires a display screen, one or more input devices, such as a keyboard, and a communication device, such as a modem or a network card. This conventional open-ended system is implemented as a text-based command line system, in which the central computing system receives user processing requests, executes the requests, and transfers the result, in the form of textual data, back to the user's terminal. The conventional multi-terminal/single server open network is especially applicable in systems attempting to maintain a low overall system cost, especially when central processing costs are burdensomely high.

User commands for this type of conventional, open-ended computer network configuration can be characterized as either foreground process requests or background process requests. Generally, open-network, user initiated tasks, such as typing, drawing, pushing buttons etc. require an immediate response from the central computing system and are classified as foreground process requests. Foreground processes are typically high priority, interrupt-driven processes requiring a relatively small number of processing cycles (e.g., 100) by the central computing system to complete the task. In contrast, a background process request is a lower priority process request requiring a relative larger amount of computing cycles (e.g., 1 billion) by the central computing system to complete the task. For example, some typical background processes can include complex iterative mathematical operations or lengthy compiling operations.

Tasks are typically submitted, each with a unique task priority. The task priority tells the central processor the relative importance of each running task such that the tasks can receive the desired amount of processing time and frequency relative to other events that are occurring. For example, a first task could be given a task priority that would disallow all interrupts and prevent any other task from running until the first task is completed. This would be the highest possible priority. On the other hand, a task could be given a task priority that would allow all interrupts, thereby limiting the execution of that task to periods when there are no other task requesting processor time. This would be the lowest priority. In practice, tasks are set in between these two extremes.

Generally, most requests are foreground or interrupt type requests that are processed very quickly by the central processor. This leaves the majority of the processing time for background tasks. If more than one of these rapidly occurring requests should occur simultaneously, all but one of these requests are selected randomly to be deferred by being placed on a queue (sometimes called a stack) while one is processed. Upon completion of the first task, any requests waiting on the queue are then serviced. The queue can hold many requests so there is no practical danger in over running the stack.

Thus, with a properly configured operating system, a number of users at different terminals, often remote from one another, can utilize a single central processing system with relatively little reduction of quality or availability of service for each user.

The advent of lower priced microprocessor technology alleviated the need for a single central computing system in favor of an individual computing system at each user terminal. Additionally, as many operating environments began implementing graphical user interfaces (GUIs) to facilitate user interaction, the computing needs for each terminal greatly increased. Unlike the conventional text-based command line systems, a graphical operating environment must generate a great deal of graphics data in order to render a single screen. For example, if a terminal screen has a resolution of 1024 pixels by 768 pixels with a 24-bit screen depth per pixel, approximately 18,874,368 bits of graphic data would be required to render the screen at one time. Additionally, if each screen is rendered 20 to 80 times a second, as may be the case when rendering moving images, the amount of data generated by the central system becomes even larger by a factor of as much as 80.

As a comparison, the conventional command line based central computing systems is implemented with data transfer speeds to the terminals of 1200 to 9600 bits per second. However, to provide the same kind of system performance in a graphical operating environment, under the conventional approach the data transfer speeds would need to be increased to 19 million bits per second. Accordingly, the increase in the amount of data to be transferred and the increase in the communication speed requirements make the conventional central computing systems impractical for use in a multi-terminal graphical environment.

One approach to allow networked “terminals” in a graphical environment is implemented as a hybrid system in which a plurality of desktop computers having individual processors are connected over a network. Instead of transferring graphics information to each terminal, the computers communicate with a common protocol that allows the Server (or Host) computer to communicate with one or more additional computers. This allows each computer to individually generate material in a consistent manner, thus allowing each user to view the same material as the Server or Host computer. One example of such a common protocol is the hypertext markup language (HTML) used extensively on the Internet. Under HTML, each desktop computer maintains a library of standard graphics such as wallpapers, textures, buttons, switches, etc. In order to cause the computer to display a graphic, a text-based command is sent to the computer instructing it as to which of the graphics from the library to display; where to display it; how large to make it etc. However, as would be understood, the hybrid system requires an individual processor at each terminal to render the graphics, thereby increasing the overall cost of implementing the network. Moreover, these attempts at a standardized graphics communication protocol, such as HTML, function poorly for transferring unique graphic images, such as a person's picture, or for transferring real time images such as those generated by a digital movie camera.

In addition to the above-mentioned limitations, many hybrid implementations must have essentially the same software running at each of the client systems as well as at the host. In this type of implementation, each computer is executing it's own program independently of the other network computers. All clients may share certain resources by using a common “system disk” or “system printer”, however, because “each terminal has its own processor” to execute code in a hybrid system, multiple copies of shared files are created, copied and stored. Users at each terminal are generally allowed to work concurrently on a personal copy of a file. These individual changes made to multiple copies of the file must at some point be consolidated into one master file. This requires that a careful and time consuming procedure is carried out to create this master integration file. If these edit copies had been created on the same system, the integration process could be performed automatically. Thus, the hybrid system has the further deficiency of having no acceptable means of allowing for concurrent modifications to the same file and the necessary re-integration that must occur. This often results in lost, flawed, or duplicative work.

Lastly, a second serious limitation to the hybrid system arises from the fact that each terminal has software that is locally installed to enable the processing that takes place at each terminal. This means that the job of software management must extend to all terminals rather than being confined to a single host. Each terminal must be considered in all software maintenance processes. Any change to the client software must be accounted for and preferably made to every client system. This may amount to hundreds of systems each needing routine software updates, resulting in significant additions to the overall operating cost of the system.

Accordingly, there is a need for an open-ended architecture computer network implementing a graphical user environment and having a plurality of remote terminals without requiring each terminal to have an independent processor.

### SUMMARY OF THE INVENTION

### BRIEF DESCRIPTION OF THE DRAWING

The present invention is described in detail below with reference to the attached drawing figures, wherein:

FIG. 1 is a block diagram illustrative of a plurality of terminals in communication with a central processing system via a communication network in accordance with the present invention;

FIG. 2 is a block diagram illustrative of the preferred components of a terminal in accordance with the present invention;

FIG. 3 is a block diagram illustrative a graphic image transfer method of the present invention;

FIG. 4 is a block diagram illustrative of a graphic data reduction method of the present invention;

FIG. 5 is a block diagram illustrative of a preferred 7-bit color depth representation in accordance with the present invention;

FIG. 6 is a block diagram illustrative of a graphical display screen in accordance with a graphic data reduction method of the present invention;

FIG. 7 is a block diagram illustrative of a change in the graphical display screen of FIG. 6 in accordance with a graphic data reduction method of the present invention;

FIG. 8 is a block diagram illustrative of a graphical display screen displaying textual characters in accordance with a graphic data reduction method of the present invention;

FIG. 9 is a block diagram illustrative of a change in the graphical display screen of FIG. 8 in accordance with a graphic data reduction method of the present invention;

FIG. 10 is a block diagram illustrative of a method of providing non-static images from a central computing system to one or more terminals in accordance with the present invention; and

FIG. 11 is a block diagram of a method of mitigating the amount of data required to provide non-static images in accordance with the present invention.

FIG. 12 is a block diagram illustrative of the preferred components of a terminal with audio capability in accordance with the present invention.

### DETAILED DESCRIPTION OF THE INVENTION

The present invention provides a method and device for implementing an open-ended computing system having a plurality of networked terminals in a graphical user interface environment. The invention is operable with numerous general or special purpose computing system environments. Examples of well known computing systems that may be suitable for use with the invention include personal computers, server computers, Note-book computers, hand-held or laptop devices, multiprocessor systems, networked personal computers, minicomputers, and mainframe computers. As would be readily understood by someone skilled in the relevant art, additional or alternative computing environments or computing components are within the scope of the present invention.

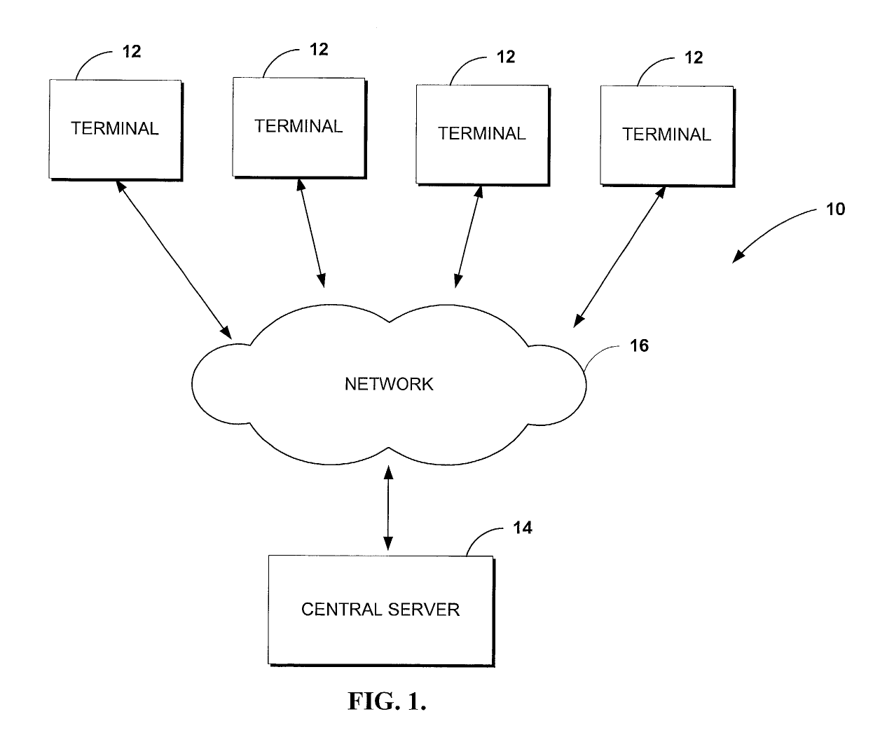

FIG. 1 is a block diagram of the graphical user interface (GUI) centralized network of the present invention, designated generally by the reference number 10. The GUI network 10 includes one or more terminals 12 in communication with a central server 14 via a communication network 16. Preferably, the communication network 16 includes a Local Area Network (LAN), such as an Ethernet link, which provides each terminal 12 access to the central server 14. As would be readily understood, the communication network 16 may also encompass Wide Area Networks (WAN) or combinations of various networking configurations.

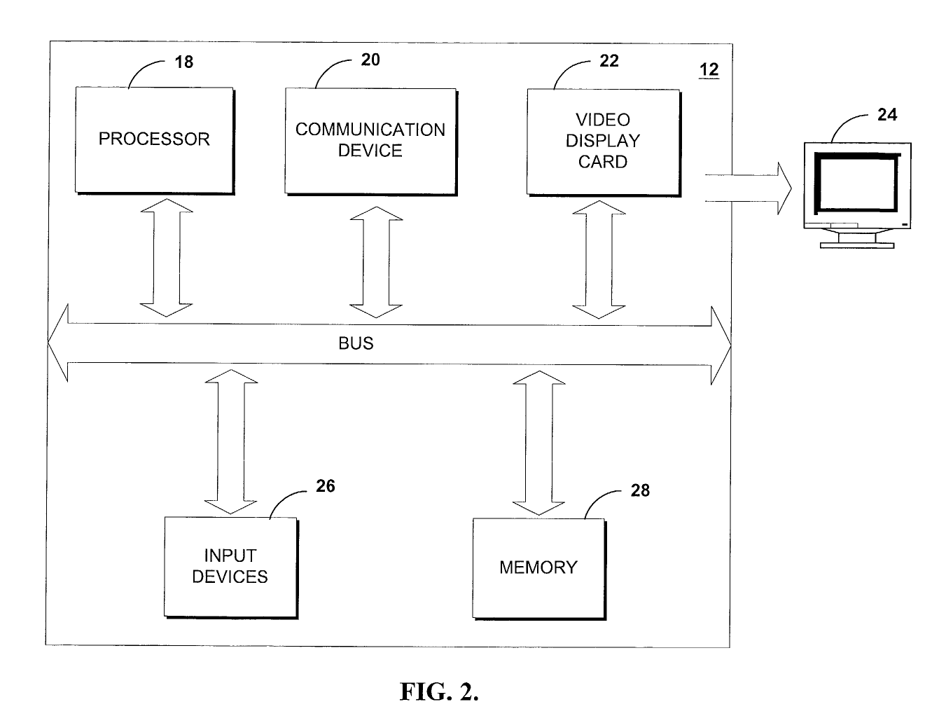

FIG. 2 is a block diagram representative of a preferred terminal 12 in accordance with the present invention. This device depicted in FIG. 2 has been implemented on a single silicon die and will be referred to as the Voicelink SCC (single chip computer). With reference to FIG. 2, each terminal 12 preferably includes a micro-controller having a minimal memory component 18, a communications device 20, such as a 10/100 Base T network interface, a video display driver 22, a terminal display 24, one or more input devices 26, such as a mouse and a keyboard.

In an alternative embodiment, a terminal 12 may be a conventional personal computer (PC) which typically have the above-listed components as well as additional components for supporting an independent operating environment. In this alternative embodiment, the PC terminal would emulate the preferred terminal 12, by executing a special program and would also be able to function as a stand-alone PC. This alternative embodiment allows the network of the present invention, with some minor software modifications, to accommodate alternative or pre-existing computing systems in the general network 10 (FIG. 1).

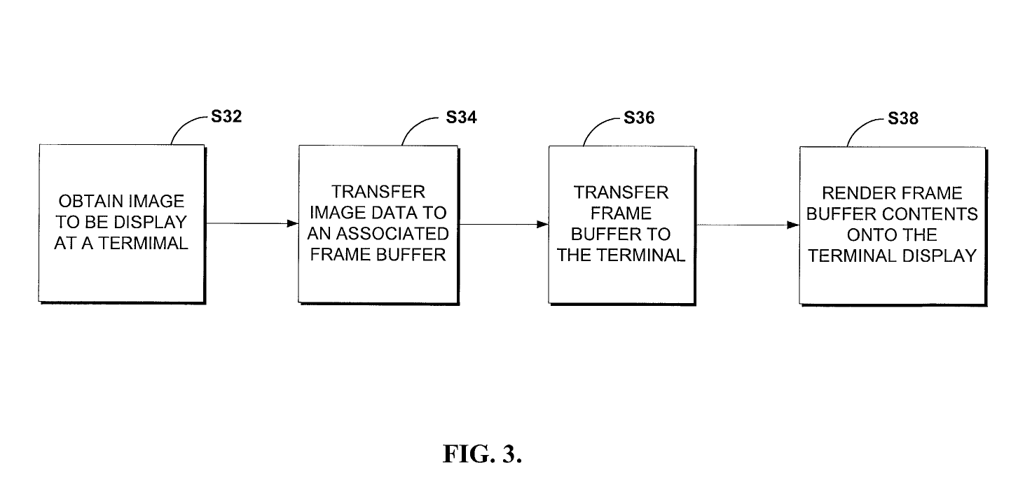

FIG. 3 is a flow diagram illustrating a preferred method of facilitating the transfer and generation of complex graphical data at a plurality of terminals without requiring vast communication or processing resources from each terminal. Accordingly, the system can be implemented at a relatively low cost per terminal, resulting in an overall lower system implementation cost. At S32, the central processor obtains the image data to be displayed at the terminal. Generally, one or more application programs running within the central graphical operating system generate the image data for the terminal. Additionally, the operating system may also generate all or portions of the image that is to be displayed by the terminal display. At S34, the central processing unit generates a screen image and deposits the image in a frame buffer associated with the individual terminal. The central processor then transmits the frame buffer contents directly to the terminal at S36. Preferably, the central processing system transfers the frame buffer data as single bursts of data occurring as a direct memory access. Alternatively, the data transfer may be broken down into two or more data transfers.

The terminal receives the frame buffer data to render the image on the display screen at S38. Thus, unlike some conventional hybrid systems which send partially encoded graphic data to be processed at the terminal, the present invention mitigates the processing needs at each terminal by transferring the frame buffer data directly to the terminal. As would be readily understood by one skilled in the art, systems incorporating alternative screen rendering tools are within the scope of the present invention.

In conjunction with the method discussed above, a method is also provided to facilitate the reduction of the amount of frame buffer data necessary for each terminal to render a screen image. A standard terminal display is composed of a pixel array on the monitor screen. For example, some standard pixel arrays include a 640 pixel by 480 pixel, 800 pixel by 600 pixel or 1024 pixel by 768 pixel. As would be generally understood, larger pixel arrays result in greater display resolution. Preferably, the frame buffer graphic data includes one or more bits utilized to define various attributes of each pixel within the pixel array. These bits are commonly referred to as the color depth, which generally define the color and opacity of the pixel. Preferably, the present invention will be described in terms of a 24-bit color depth. Accordingly, the amount of graphics bit data necessary to render a terminal screen equals the number of pixels in the pixel array multiplied by the 24-bit color depth for each pixel. As would be readily understood, different pixel array configurations and/or color depth sizes are within the scope of the present invention.

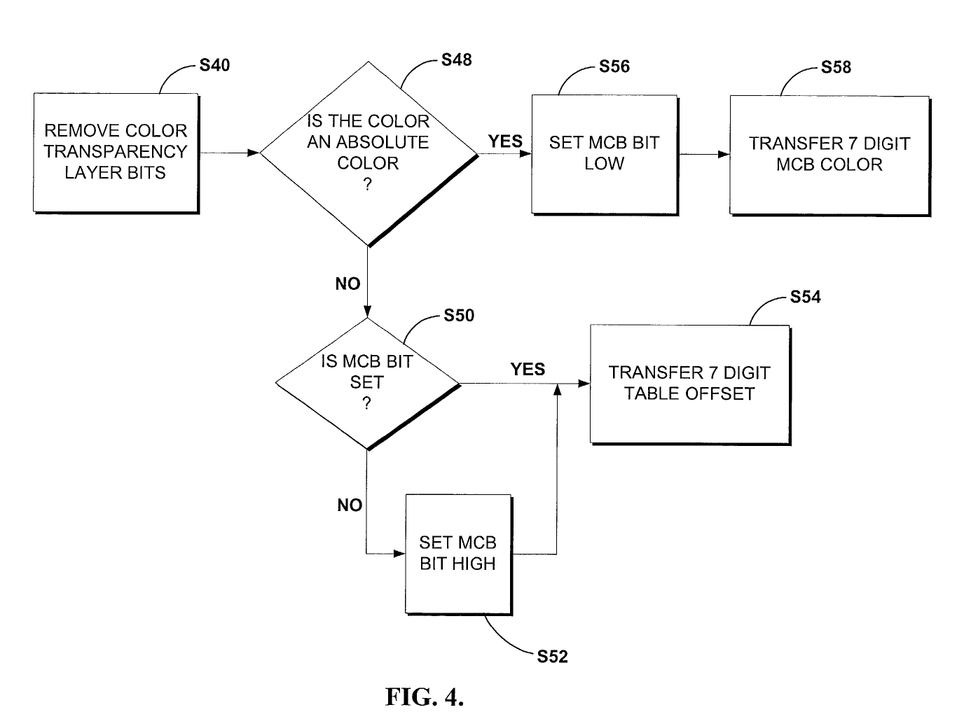

FIG. 4 is a block diagram of a preferred method of reducing the amount of pixel data necessary to render a graphic image on a terminal display in accordance with the present invention. Specifically, the present invention reduces the amount of color depth data necessary to define each pixel. As mentioned above, conventional color depth is preferably defined in 24 bits of data. Generally, 8 bits are used to define pixel transparency.

In complex graphical images, overlapping drawing objects are blended together to create multiple layers on the display. If the top layer display object is attributed a transparency, the user views some or the entire underlying display object layers when the image is rendered. Accordingly, the 8-bit portion of the color depth allows the software or hardware to properly render the drawing object layers.

With reference to FIG. 4, at S40 the 8-bit transparency portion of the color depth data is removed from the graphics data. Because the present invention processes the image data at the central processor and transmits the frame buffer data to the terminal, the terminal video card does not need to process the data. Accordingly, although the 8-bit transparency data is important to correctly generating the image, it is utilized at the central processor level and can be completely disregarded by the terminal. After the 8-bit transparency data is removed, 16 bits of color depth data remain, which are generally utilized to create the various color attributes of the pixel. Generally, the present invention reduces the remaining color data into an 8-bit representation yielding an effective 14-bit resolution. Accordingly, the remaining two bits of color data are lost in this embodiment.

To facilitate the encoding of the 14 effective bits into an 8-bit representation, the present invention categorizes the remaining color data into two effective types of images. The first class of image is a single or multi-color image defined by one or more of 128 distinct colors. Accordingly, each color is given a unique 7-bit representation.

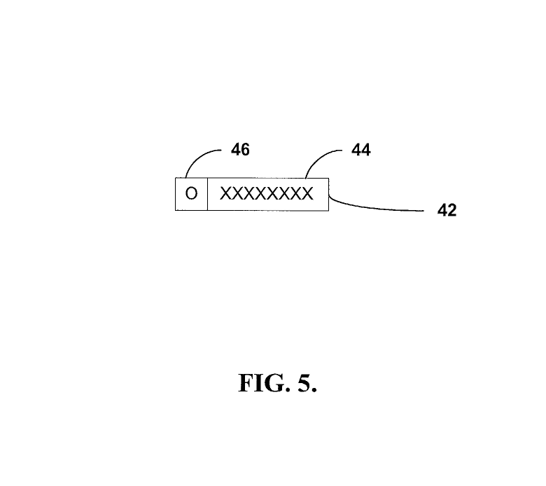

FIG. 5 is a block diagram illustrating a preferred 8-bit representation 42 of the 14 effective color bits. In this embodiment, the eighth bit 46 designates which of the two image classes the color data represents. Preferably, the eighth bit is referred to as the master color bit (MCB). If the MCB is low, the image is an absolute color image and the remaining seven bits identify the absolute color. The remaining seven bits to obtain the 14 bit effective resolution are considered to be all zeros in this case. This is because we have an absolute color match.

The second category of images are generally images that include pixels having a gradient of one of the absolute colors. To facilitate the use of the 8-bit designation, the remaining 7 bits define a shade offset of a previously defined absolute color. For example, a first 8-bit designation, “0xxxxxxx”, defines a pixel in an absolute color and also defines the master color as the 7-bit portion of the 8-bit designation. If the following pixel's 8-bit designation is “1xxxxxxx”, the terminal display utilizes the 7-bit portion to define a shade offset from the previously saved master color. Accordingly, if the next pixel's 8-bit designation is “1xxxxxxx”, the terminal display continues to apply the 7-bit portion as an offset. This will continue until and unless a pixel's 8-bit designation is “0xxxxxxx” at which point the 7-bit portion defines an absolute color, which becomes the new master color for any subsequent offsets.

With reference again to FIG. 4, once the transparency bits have been removed from the original 24-bit representation at S40, the method queries whether the pixel is represented by an absolute color at S48. If the pixel is not an absolute color, the method determines whether the MCB bit is set at S50. If it is not, the MCB bit is set at S52 and the 7-bit portion defines the offset color of the pixel at S54. If at S50, the MCB bit is set, the 7-bit portion defines the offset color of the pixel at S54. If at S48 the pixel color is an absolute color, the MCB bit is set to low at S56 and the 7-bit portion defines the absolute color at S58. As would be readily understood, alternative representations of the MCB bit or the designation of color or offset are considered within the scope of the present invention.

The encoding scheme defined above can also be used in a second mode where it defines 16,384 shades of gray. In this mode the client simply relates all codes to a shades of gray look up table, rather than a color table.

An additional encoding scheme allows for the color depth to be one bit. This mode is used automatically anytime there are only two colors and no gradients. Such as black print on a white background. When using this method, the client arbitrarily assigns the color black to the foreground and white to the background. In this mode, the color for the foreground and background may be manually adjusted on the client system.

In a further aspect of the present invention, a method is provided to facilitate the reduction in the amount of data necessary for the terminal to maintain or modify the image once the image has been rendered. As mentioned above, a graphic image for a standard 800 pixel by 600 pixel with a 24-bit color depth would require approximately 11.5 MB of data to render. Even with the practice of the color depth reduction data of the present invention, the rendering of the screen would still require approximately 3.83 MB of data to render a graphic screen each time. Accordingly, the present invention is also directed to reducing the amount of graphic data that is necessary to update the terminal image once it has been rendered.

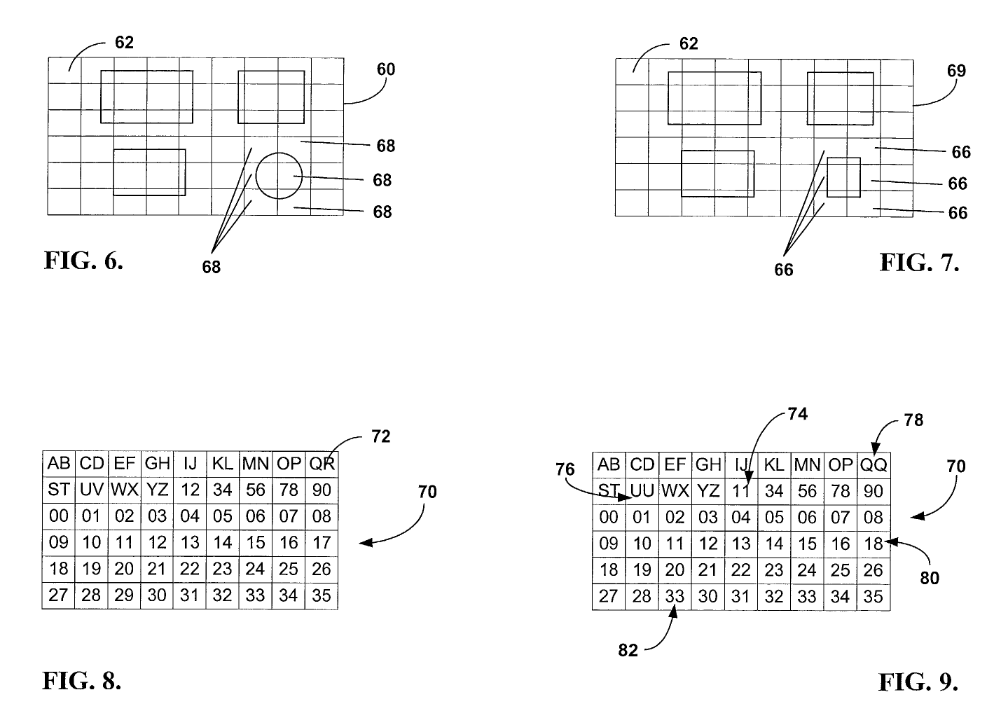

FIG. 6 is block diagram illustrative of a graphical display screen. Preferably, the display screen 60 is organized into a plurality of smaller sub-squares 62 that cover the entire display screen area. With regard to the previous example, 600 pixel by 800 pixel display screen, the display screen could be preferably organized into 32 pixel by 32 pixel sub-squares, requiring approximately 468 sub-squares to cover the entire screen. Utilizing 1 bit color depth each sub square requires 1024 bits. As such, the 8-bit color depth representation of the present invention would require approximately 8096 bits of data to render each sub-square. Accordingly, once the image is rendered for the first time, requiring the sending and rendering of 468 sub-squares, the present invention reduces the amount of data needed to update the screen by only sending those sub-squares for which the image has changed.

Further, the sub-squares are rendered in the order of left to right, then down a line and a left to right again. If a sub-square is the same as the previous, then a repeat code requiring only one byte is sent rather than sending the entire sub-square of data. If the same sub-square occurs again, then another repeat code is sent. If all squares are the same, then only the first sub-square will actually be sent. The remaining bytes will be repeat codes. Other codes that can be sent are:

1. Repeat a specified color x times

2. Repeat a specified color to end of screen

3. Entire screen to specified color

4. Render as background

The above codes require that one byte is used in the sub-square header. The background code number 4 requires that the predominant color is sent as part of the page header. Any sub-squares that appear as background are called out as background.

FIG. 7 is a block diagram illustrative of a change in the graphical display screen of FIG. 6 in accordance with a graphic data reduction method of the present invention. With reference to FIG. 7, the display screen 64 is organized into the same amount and configuration of sub-squares as the display screen 60 of FIG. 6. Accordingly, an inspection of the sub-squares reveals that only the lower right hand block of squares 66 contains any changed images from the original lower right hand block of squares 68. Accordingly, the present invention preferably mitigates the data necessary to update the screen by transmitting only those squares that have updated graphic information. In this example, the entire screen could be updated utilizing only about 2K of graphic data. All updates are one of four specific types. The rendered screen is analyzed by software routines and a choice is made as to which protocol and compression type to use.

TYPE 1 is a “lossy” color image compression method and is encoded into a format similar to Joint Photographic Experts Group standard (“JPEG”). This type is generally used for images that are fixed images and will not change during execution of the program. The command to use the Type 1 encoding is embedded into the image itself. These images require an average of 40K bits to send.

TYPE 2 is a “lossless” text image compression method and uses the sub-square updating method discussed earlier. An image that is known to be primarily a text image as opposed to a combination of text and multicolor graphic image arrays may be encoded using sub-square encoding and a one bit color depth with a header identifying the two colors used. The header information is sent only once at the beginning of the page send. A full page using Type 2 requires approximately 400K bits, however, using the additional reduction techniques in the sub square method, the average page of text requires approximately 40K bits/page

TYPE 3 is a “lossless” color image encoded with the 8 bit-encoding scheme defined in this document. After the first pass of 8 bit encoding is completed, the average page is approximately 800,000 bits. This file is compressed mathematically to obtain a 12 to 14 by 1 ratio. This is an additional compression which results in an average page using Type 3 of about 50K bits/page.

TYPE 4 is a “lossless” text image compression method and uses the sub-square updating method. A text image that is known to be primarily a text image, as opposed to a combination of text and multicolor graphic image arrays, may be encoded using sub-square encoding and a one bit color depth with a header identifying the type and the two colors used. This encoded information is sent only once at the beginning of the page send. Whereas a full page using Type two requires approximately 400K bits, using the additional reduction techniques in the sub square method, the average page of text requires approximately 40K bits/page

The update methodology of the present invention can be applied in a variety of graphic screen scenarios. For example, a user may request a defined area of the screen to be updated. Alternatively, the central computing system may also update defined areas in the event of screen activity or some other event requiring such a response. Moreover, the user may also be given an opportunity to request a full-page update. Any variety of events, either user initiated or central controller initiated, could cause various forms of sub-square or full screen updates. Using a high-speed data link, such as DSL, which offers service at approximately 1.5 Mbps, any of the compression types listed above can render a page to the client in approximately 1/30^{th} of a second. Thus any of the above compression types are adequately effective at compressing data such that with any one of them it would be possible to show moving pictures or precise, lossless, still shots.

If a modem is used, (limiting the data rate to about 56 k bps,) the methods of the present invention facilitate acceptable performance. The frame size may be reduced in order to limit the amount of data that needs to be sent during a moving picture from any of the standard pixel arrays (640×480 or 800×600 or 1024×768) to 320×200 bits.

Additionally the following relationship is applied: As the motion increases, resolution (bits per frame ) is reduced and the frame rate F is increased. Hence, the net amount of data sent is about the same when averaged over time regardless of whether the image is moving or still. This relationship is the key to achieving a successful motion picture at low data rates. If a sub-square has a significant amount of change in its content compared to the sub-square sent for the same location last page, then it should be sent with medium or low resolution. If there is a small amount of change then it should be sent as high resolution. If there is no change, then send a repeat code.

The choice of which type to use is based on the type that will yield the best result given the image type being compressed. This is sometimes determined by a non-viewable code built into the page itself. Otherwise, the host software makes the determination.

In addition to the frequency and size of the screen updates in accordance with the present invention, the central computing system can also address a variety of special exception updates to improve user interaction. A first exception update involves the implementation of user pointing devices, such as a mouse. In accordance with a general implementation of the present invention, the terminal receives user pointer input and transfers the user input to the central computing system. Accordingly, the central computing system would process the input and would then generate the resulting image to be transferred back to the terminal. Irrespective of the communication speed of the terminal/Central Computing Network and the processing speed of the central computing system, a delay in the processing causes the mouse pointer image to be “jumpy” with reference to the user's real time movement of the input.

The present invention mitigates the input delay by generating a mouse pointer image at the terminal. In this embodiment, the terminal, with some minimal processing, receives the input, transfers the input to the central computing system, and then generates a mouse image to be rendered locally. Local rendering is accomplished by taking the mouse input x, y coordinates, which are two fields that increment, decrement or remain unchanged according to mouse movement. These two numbers describe the exact x, y position of the tip of the mouse-pointing arrow. Once the x, y position is known, then the x, y coordinates of all the necessary pixels to paint any shape can be easily defined. For example, the pointer location is 10,10, which is the same as location 100. We have a ROM table of location offset values for an arrow by adding the actual location to each of the ROM values, we know the location for all the arrow pixels in our design we force the video output to white or black when the pixel location pointer is equal to any of our saved values. Once the value is gone from the table, then the pixel color will revert to normal. The mouse arrow is repainted at the same rate that the display is refreshed (about 30 times per second). Note that in this method the mouse arrow is never painted as a part of the screen it is merely used to define areas forced to white while the actual image value remains. This is the cause of the reversion why it reverts back to the real image when the arrow is gone.

In a similar context, the blinking of a standard cursor, such as in a word processing application, may also demonstrate some “jumpiness” when processed in accordance with the present invention. Likewise, the present invention mitigates the jumpiness by allowing the terminal to generate an image of the cursor locally while continuing to process the input at the central computing terminal. In this embodiment, the central computing system maintains the cursor's location based on the various inputs by the user. However, instead of generating and updating the cursor graphics, the central computing system sends the terminal an update of the cursor's location and the terminal generates the image with no “jumpy” effect.

In another similar context, the present invention also mitigates the sending of additional update information for graphics having two or more defined states. For example, many graphical operating systems provide a user with “buttons” that are depressed to implement some functionality. Accordingly, the display of the button is either pressed or not depressed. The general application of the methods of the present invention would require screen image information to be updated each time the button would be depressed.

To mitigate the amount of data transmitted over the network, the central computing system can transfer various states of the graphics objects to the terminal prior to the state being required. Accordingly, the central computing terminal would only be required to communicate to the terminal to render one of the states each time the state of the graphics object changed as opposed to re-sending the updated graphic each time.

The present invention also mitigates performance degradation with respect to keyboard input by the user at each terminal. Similar to the performance degradation associated with a user movement of an input device, under the general system, keyboard strokes on the terminal would be transmitted from the terminal to the central processing system, processed, and an updated graphic image would be transmitted back to the terminal. Delays in the transmission time or in the processing time would generate “jumpy” graphics in which multiple textual characters would be updated sometime after the keyboard strokes would be entered.

FIG. 8 is a block diagram illustrative of a graphical display screen displaying textual characters in accordance with a graphic data reduction method of the present invention. Preferably, the graphics screen 70 is organized into sub-squares to cover the entire area having the textual character capability. Additionally, each sub-square is preferably sized to fit approximately two characters within each sub-square. As textual data is updated, the central computing system updates the screen per the amended sub-square. Accordingly, by defining a two-character sub-square, the image is updated in two character blocks.

FIG. 9 is a block diagram illustrative of a change in the graphical display screen of FIG. 8 in accordance with a graphic data reduction method of the present invention. As illustrated in FIG. 9, the textual data has been updated. However, based on the organization of the display into the two-character blocks, only blocks 74, 76, 78, 80 and 82 have new text. As such, the data required to update the screen is limited to the amount of data required to transmit only those five blocks.

In cases where a slow data link is utilized, another method of mitigating delays perceived while typing can be used. As a character is entered at the keyboard of the client, it is directly routed to the screen and rendered through a completely local process as this happens, the data is simultaneously sent to the host where it is processed in the normal way. The host will send the character to the client after it has been rendered locally. The character sent from the host will merely overwrite the character at the client. If there is a communication error, the character will be overwritten with an error code. The net effect is that of having almost no delay whatsoever.

In combination, the two-character pixel square and the character echo are utilized to reduce the amount of data needed to update and to reduce the amount of time between the user entering a character and seeing the character on the terminal display.

In addition to the processing of static graphic images, the present invention is also applicable with the transfer of non-static images, such as streaming video to the terminals from the central computing system.

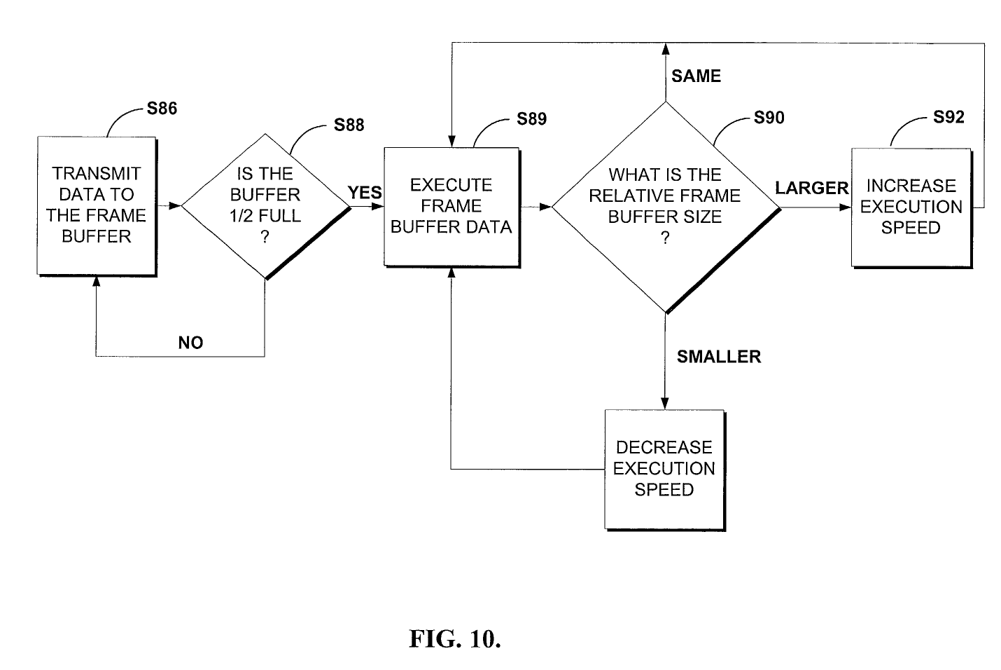

FIG. 10 is a block diagram illustrative of a preferred method of implementing streaming video from a central computing system to one or more terminals in accordance with the present invention.

With reference to FIG. 10, at S86, the central server begins transmitting and accumulates the data into a streaming data buffer. At S88, the non-static data, such as audio data, video data, or both, are transferred at an initial rate that is generally established by the central system crystal. At S86, the terminal receives the data signal process until the input buffer is approximately half full. Once the buffer is half full, the terminal, executes the data input from the buffer at S89.

As would be generally understood, if the rate of the central system streaming data equals exactly the rate that the terminal executes the data in the buffer, the streaming process would not require any regulation. However, because of differences in the execution rate of the buffer data and the input rate from the central computing system, the size of the buffer will increase or decrease by the difference in the two rates. Preferably, the terminal is instructed to execute buffer data based on the raising of a master video bit. The master video bit of the terminal is preferably a bit that is set after a fixed number of master clock cycles are accounted for in a counter. For example, if a master clock is set at a frequency of 100 MHz, each cycle is 10 nanoseconds. Thus, the master video bit could be set every four clock cycles, or every 40 nanoseconds.

With continued reference to FIG. 9, at S90, the size of the buffer is monitored. If the buffer size is growing as the buffer data is being executed, which implies that the terminal clock speed is slower than central computer system clock speed, then the terminal clock speed is increased at S92. Preferably, with reference to the above-example, decreasing the number of clock cycles required before the master video bit is set increases the terminal clock speed. If data remains in the frame buffer, execution returns to step S89. If at S90 the size of the buffer is decreasing, implying that the terminal clock speed is faster than the central computing system clock speed, then the terminal clock speed is decreased at S94. If data remains in the frame buffer, the method returns to the execution step at S89. Finally, if at S90 the size of the buffer is unchanged, or relatively unchanged, the method returns to the execution step at S89.

In addition to providing streaming video to one or more terminals, the present invention further limits the amount of data transmitted across the network. It has been found that updating a terminal display image 30 times a second maximizes the image quality. Moreover, it has been found that update rates of 20 times per second are adequate for most video images. As would be generally understood, a higher number of moving images in a streaming video reduces the amount of granularity required to maintain an adequate image. Accordingly, the amount of data sent per screen can be reduced for a higher number of screens per second.

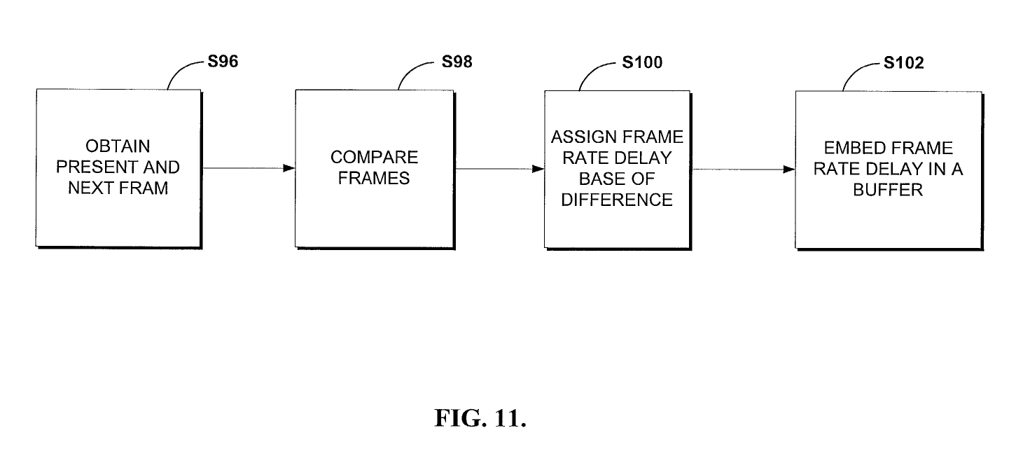

FIG. 11 is block diagram illustrative of a method of mitigating the amount of data required to provide non-static image transfers from the central computing system to one or more terminals. At S96, the central computer system obtains the present frame and the next following frame. At S98, the two frames are compared. Based on the relative differences between the two frames, a frame rate is assigned at S100. Preferably, the present invention includes frame rate information in the header of each frame of the non-static image. Accordingly, the terminal will have the ability to vary the frame rate on a per-frame basis. The central computer system will also have the ability to monitor the frames on a multiple frame basis to choose the best image transfer rate. Essentially, as the number of frames per second goes up, the amount of data contained in each frame goes down. The concentration of data may also be adjusted such that when an image is changing significantly and the change is contained in a small part of the frame, that portion of the frame receives a higher share of the allotted data for the entire frame.

Preferably, the present invention has been described in relation to other static and non-static video signals transmitted from the central computing system to each of the terminals. Alternatively, the present invention can also be applied in combination to an audio application.

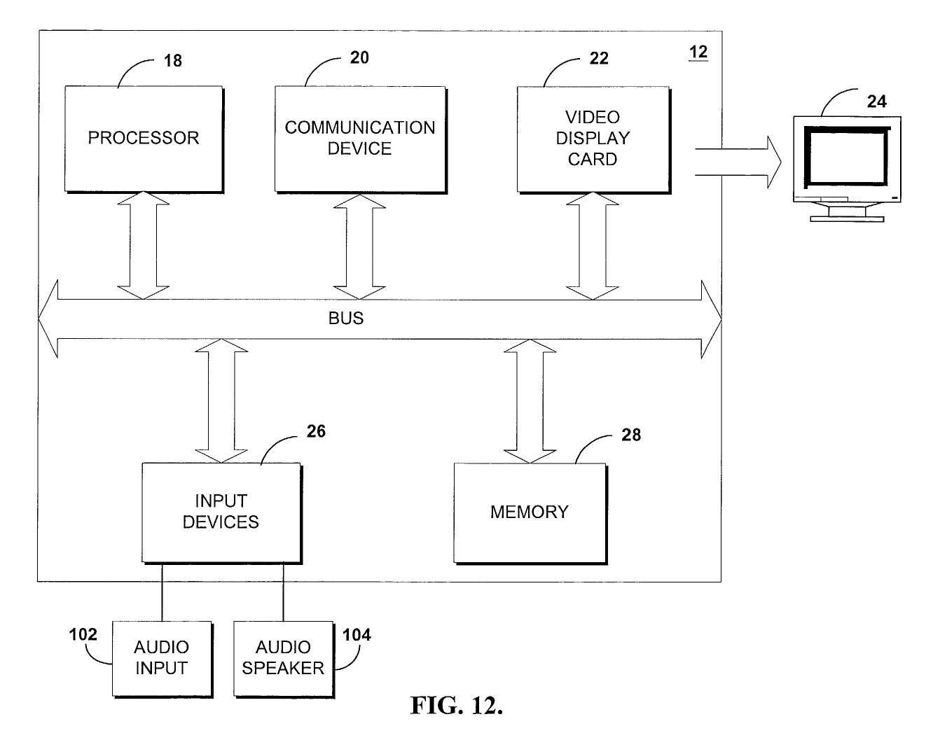

FIG. 12 is a block diagram illustrative of a terminal having audio feeds to the central computing system. In this embodiment, each user can have access to a number of audio lines limited only by the bandwidth of the networked terminal connection. For example, and with reference to FIG. 12, each terminal 12 (FIG. 1) includes an audio input device 102 such as a telephone or a microphone. The input device 102 of the terminal transmits the audio data to the central computing system, which processes the input in accordance with the various methods of the present invention. The central computing system is then preferably connected to a number of external audio sources, such as an asynchronous transfer module (ATM) leaf of a telephonic line, which will then enable a telephone call to be executed.

In reverse, upon receiving an incoming signal from the external source via the ATM leaf, the central computing system transfers the incoming signal to a terminal that is assigned to a recipient user. Alternatively, the user can be logged into any terminal within the system and the central computing system will transfer the incoming audio signal to the user. The user would then be able to communicate via the audio input 102, and/or an audio speaker 104.

In a further application of this method, the present invention also allows the user to have multiple audio lines at the same time. For example, a user may initiate a first telephone call via the central computing system. If the user wishes to place another call, or if he or she receives an incoming call while still on the first call, the central computing system merely establishes a second audio line with the terminal. Because the audio data is being transmitted over a network having a large bandwidth, the user is not limited by a fixed number of telephonic lines. Instead, the user is solely limited by the amount of data the network bandwidth is capable of supporting.

Additionally, each user on the network can preferably have access to the system from any one of the terminals connected to the system. For example, a user initiates a first audio signal at a first terminal. The user could then log into a second terminal and establish a second audio line. In a second example, a user may begin an audio link at a first terminal and pick up the link at a second terminal as well. This would facilitate “conference calling” or a mobile user.

As described above, the data transmitted over the network is preferably encoded to reduce the amount of data being transmitted over the network. In addition to the compression of the data, the encoding of data by the present invention also provides security for the user and limits unauthorized access to information. For example, the data being transmitted over the network can be encoded utilizing a key. Because a key is unique to each terminal, the data cannot be read by anyone intercepting messages without access to the key.

The security aspect of the present invention also pertains to audio data that is transmitted over the network. As would be understood, the present invention can use additional security features such as erasable plug-in cards to ensure that the encryption keys will be erased in the event that they are tampered with.

The present invention has been described in the terms of static or non-static images for reducing the amount of graphical data being transmitted over the network. In yet another application of the present invention, a comparison of frames of video data, either static or non-static data, may also serve the purposes of an alarm system. For example, assume a still camera is placed in an area to be monitored. The user could log into the system and monitor the status of the premises based on viewing the pictures. Moreover, the central computing system can also monitor images to verify whether any of the images have changed. In accordance with the data reduction methods of the present invention, the central computing system would monitor the input signal and would only produce an update window command if there were a change in the image. Assuming no movement, the central computing system would detect no change or minimal change in the frame data. If, however, the computing system should detect a change in the frame buffer data, it would indicate that the data signal had changed and that there was movement within the premises. Accordingly, the computing system could either warn the user by a variety of enunciation means, or could initiate a police reaction to verify that the premises were secure. In another application of the above methods, the change in data compaction method can also serve as an alarming feature.

As would be generally understood, there are additional applications of the present invention that would benefit from the data handling methods of the present invention. All of these are considered within the scope of the present invention.

I claim:

1. A computer system, the system comprising:
one or more terminals; and
a central server in communication with the one or more terminals;
wherein the central server generates data indicative of a frame buffer for each of the one or more terminals and transmits the frame buffer data to the terminals.

2. The system as recited in claim 1, wherein the central server is remote from the one or more terminals and is in communication via a network.

3. A method in a computer system for generating and displaying graphics on a display screen, the method comprising:
generating frame buffer image data comprising the graphics to be displayed; and
transmitting the frame buffer image data to a terminal.

4. The method as recited in claim 3, wherein the frame buffer image data of all the possible states of an object are transferred to the terminal before they are needed; and including the step of
transmitting a command to indicate which frame buffer image data should be rendered at the terminal.

5. The method as recited in claim 3, further comprising: encoding image data color information;
reducing the number of bits representative of pixel color depth in the generated frame buffer image;
sending a limited number of bits to the terminal for rendering the graphics; and
decoding the reduced bit representation at the terminal.

6. The method as recited in claim 3, further comprising:
generating a second set of frame buffer image data comprising the graphics to be displayed as an update of the first frame buffer image data;
determining any changes between first frame buffer image data and the second frame buffer image data; and
transmitting the changes to the terminals.

7. The method as recited in claim 3, wherein an algorithm is applied to inversely relate the rate of display of the frame image data to the resolution of the displayed image, to maintain the quantity of transmitted data.

8. The method as recited in claim 6, wherein an algorithm is applied to inversely relate the rate of display of the frame image data to the resolution of the displayed image, to maintain the quantity of transmitted data.

9. The method as recited in claim 3 further comprising:
computing of a frame rate of transmission;
incorporating of said frame rate into the image data that is to be displayed;
varying the frame rate of transmission on a per-frame basis;
selecting and transmitting the best frame image data either in its entirety or in portions.

10. A computer readable medium having computer executable instructions for performing the method recited in claim 3.

11. A computer system having a processor, a memory and an operating environment, the computer system operable to execute the method in claim 3.

12. A method for communicating between a terminal process and a central server process, the method comprising:
issuing by the central server process; frame buffer image data indicative of a screen image to be displayed by the terminal;
receiving by the terminal process the frame buffer image data;
displaying by the terminal process the frame buffer data on a display screen;
receiving by the terminal process input indicative of a user action;
transmitting by the terminal process the input to the central server; and
issuing of frame buffer image data by the central server process indicative of the change in the frame buffer data corresponding to the user action input.

13. The method as recited in claim 12, wherein the user action includes receiving an input from a user selection device.

14. The method as recited in claim 13, wherein the user selection device is a mouse, a keyboard or other user input device.

15. The method as recited in claim 12 further comprising:
generating a graphic indicative of the user action.

16. The method as recited in claim 15, wherein said graphic is a cursor image, local mouse pointer or keyboard entered character.

17. A computer readable medium having computer executable instructions for performing the method recited in claim 12.

18. A computer system having a processor, a memory and an operating environment; the computer system operable to execute the method in claim 12.

19. A method for generating an updated character transmission, the method comprising:
generating a display screen to be displayed;
transmitting the display screen to a terminal;
characterizing the display screen into two or more areas;
storing textual characters within the two or more areas in a memory;
generating an updated display screen; comparing the textual characters within the two or more areas of the updated display screen with the textual characters in the memory; and
transmitting to the terminal only the areas having different textual characters in the updated display screen.

20. The method as recited in claim 19, wherein said textual character is locally rendered by the terminal.

21. The method as recited in claim 20, wherein the textual character is overwritten by a subsequent character generated at a central server.

22. A computer readable medium having computer executable instructions for performing the method recited in claim 19.

23. A computer system having a processor, a memory and an operating environment, the computer system operable to execute the method in claim 19.

24. In a computer system having a graphical user interface including a display and a user interface selection device; a method of generating graphics indicative of a user selection device; the method comprising:
receiving data indicative of a bitmap image to be displayed on the display screen;
receiving data indicative of an input from the user selection device;
displaying a graphic indicative of a movement of the user selection device corresponding to the input from the user selection device;
transmitting the data indicative of the input from the user selection device; and
receiving data indicative of a change in bitmap image to be displayed corresponding to the input from the user selection device.

25. In a computer system having audio capability including a terminal process and a central server process, a method of handling audio data connections comprising:
routing connection at the central server to one or more terminals;
initiating calls from a terminal; and receiving and processing connections from a single user at one or more terminals to make the call.

26. The method in claim 25 wherein, a first terminal initiates a call via a connection to the central server and a second terminal is able to receive and maintain said connection.

27. The method in claim 25 further comprising:
encoding the data associated with the connection to enhance security and data compression.

28. A computer readable medium having computer executable instructions for performing the method recited in claim 25.

29. A computer system having a processor, a memory and an operating environment, the computer system operable to execute the method in claim 25.
